(19) United States
(12) Patent Application Publication
(10) Pub. No.: US 2008/0155548 A1
(43) Pub. Date: Jun. 26, 2008

(54) AUTONOMIC LOGGING SUPPORT

(75) Inventors: Richard D. Dettinger, Rochester, MN (US); Frederick A. Kulack, Rochester, MN (US); Richard J. Stevens, Mantorville, MN (US); Eric W. Will, Oronoco, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation

(21) Appl. No.: 12/039,961

(22) Filed: Feb. 29, 2008

Related U.S. Application Data
(62) Division of application No. 10/431,917, filed on May 8, 2003.

(51) Int. Cl. G06F 9/46; G06F 17/00

(52) U.S. Cl. 718/102; 707/202; 707/E17.007

(57) ABSTRACT

A system, method and article of manufacture for event management in data processing systems and more particularly to managing events occurring in data processing systems in order to provide an effective logging mechanism. One embodiment provides a method of generating log file entries for events occurring during execution of a process in a data processing system. The method includes determining an importance level for an occurred event on the basis of trend analysis indicating evolution of the process and creating a log file entry for the occurred event if the determined importance level exceeds the predetermined threshold value.

### CROSS-REFERENCE TO RELATED APPLICATIONS

This application is a divisional of co-pending U.S. patent application Ser. No. 10/431,917, filed May 8, 2003, which is hereby incorporated by reference.

### BACKGROUND OF THE INVENTION

1. Field of the Invention

The present invention generally relates to event management in data processing systems and more particularly to managing events occurring in data processing systems for providing an effective logging mechanism.

2. Description of the Related Art

A process running on a data processing system, including but not limited to distributed or parallel processing systems, may produce a running log which provides details associated with various events which occur when performing processes. These processes produce event logs or activity history logs whose size cannot be determined beforehand. While it is the case that the processes that generate such logs generally fall into the category of non-interactive processes such as daemons, interactive processes are also capable of generating messages and event descriptions that are stored in a log file. These log files, or more commonly “logs,” are especially useful for tracking execution of processes and postmortem debugging and problem analysis. Accordingly, effective logging is a critical function in correctly working processes for tracking purposes and especially in unusual failure situations for problem determination and resolution.

Some long running processes, for instance, daemon processes such as those which are distributed over many nodes in a distributed data processing system, may generate log files which are very long. The system is thus compelled to create large activity logs which require an appropriate mechanism for storage and later retrieval, if necessary. However, it is not desirable, and it is sometimes unacceptable, to produce log files of an unlimited or even indeterminately large size. In general, log files of uncontrollably large size are undesirable since they limit storage, inhibit performance and add to the administrative overhead and burden of data processing systems.

Some data processing applications solve the problem of log file size management through the use of techniques which limit the size of the log file. This may be accomplished in several ways. In a first approach the file may be restricted to a certain maximum size and entries made to it are made in a first-in-first-out manner (finite sized push down stack) when the maximum file size is reached. In a variant of this approach, also known as “wrapping”, early file entries are overwritten when the maximum file size is reached. In yet another approach to this problem, a rotating file structure is provided so that, if the log file reaches a certain limit, subsequent log entries (also referred to herein as “log file entries”) are written to a completely new file. For example, if the current log file exceeds the predetermined limit for log file size, the current log file is named as a backup file and another log file is created with the current log file name. Yet another approach to this problem is simply to arbitrarily reduce the number of log file entries that are generated. However, this approach defeats the very purpose of maintaining an accurate and detailed event history. Although such abbreviated files are more easily managed, their content is often significantly lacking in the details desired for report generating purposes. While all of these approaches to the problem provide some help in limiting the amount of storage utilized, there are still several problems that are not solved by any of these methods.

In addition, when the log file is truncated and wrapped many times, it is very often not possible to track certain important event or activity entries. The “wrapping” approach is thus seen to be particularly disadvantageous if a problem occurs at a customer site or at a remote site and the lost log entries provide the key elements needed to determine solutions to an underlying problem. For instance, while not directly related to the problem at hand, application or process initialization information often proves critical in solving the underlying problem. Corresponding log entries are produced at the beginning of process execution and, thus, stored at the beginning of a corresponding log file. If the log file is truncated and wrapped, the process initialization information stored at the beginning of the log file is generally lost. In such circumstances, this approach clearly demonstrates that it has major drawbacks.

Another significant disadvantage that exists for conventional logging approaches is that they do not provide any granularity based upon the absolute or even relative importance of the event or activity log entries. The absolute importance refers to log file entries which are more important than other entries with respect to events occurring in the running process. The relative importance refers to log file entries which are more important than other entries with respect to status changes in the data processing system on which the process is running. Specifically, the relative importance indicates effects of events occurring in the running process on the system resource usage in general. These important log entries tend to be especially useful for after-the-fact debugging and/or analysis. In fact, such important event or activity log entries may provide critical information for debugging/analyzing a problem appearing in the running process which may cause system failure and that needs therefore to be resolved.

More specifically, in many cases an underlying problem will only surface when the system is under tremendous stress. Thus, as mentioned above, using conventional logging mechanisms the important log entries may be embedded in an enormous log file having an unlimited or even indeterminately large size. This enormous log file would however include a large number of log entries which are irrelevant to the problem to be resolved. For instance, if the process is running in a large scale application several days or weeks before the problem surfaces, usually a very large number of log file entries is created. In general, most of the log file entries are only relevant for tracking purposes confirming that the running process is correctly performing. These log entries would, however, contain information which is not critical to a problem that needs to be resolved when failure occurs. This irrelevant information would unnecessarily slow down the debugging process as the critical information needs generally to be distinguished from this irrelevant information manually by an operator before the problem may be analyzed. Furthermore, the operator needs to associate the critical information with occurred status changes in the data processing system in order to determine the effects of certain occurred events on the status of the data processing system when trying to resolve the problem. Consequently, this approach is time-consuming and involves significant costs.

Therefore, there is a need for an effective event management in order to provide an efficient logging management mechanism for generating log file entries on the basis of the absolute or even relative importance of corresponding process events or activities.

### SUMMARY OF THE INVENTION

The present invention is generally directed to a method, system and article of manufacture for event management in data processing systems and more particularly for managing events occurring in data processing systems in order to provide an effective logging mechanism.

One embodiment provides a method of managing logging activity for a process in a data processing system. The method comprises monitoring at least one system status parameter for the data processing system and managing the logging activity for the process on the basis of the at least one system status parameter.

Another embodiment provides a method of generating log file entries for events occurring during execution of a process in a data processing system. The method comprises determining an importance level for an occurred event on the basis of trend analysis indicating evolution of the process and creating a log file entry for the occurred event only if the determined importance level exceeds the predetermined threshold value.

Still another embodiment provides a computer readable medium containing a program which, when executed, performs an operation of generating log file entries for events occurring during execution of a process in a data processing system. The operation comprises determining an importance level for an occurred event on the basis of trend analysis indicating evolution of the process, comparing the determined importance level with a predetermined threshold value and, only if the determined importance level exceeds the predetermined threshold value, generating a log file entry for the occurred event.

Still another embodiment provides a computer readable medium comprising an event manager program for initiating a background thread for each instance of an executing application in a data processing system, the background thread being configured to: monitor at least one system status parameter for the data processing system, monitor one or more processes running in the data processing system in order to detect events occurring in the one or more processes, associate an importance level with each occurred event and identify a predetermined action to be taken in the data processing system on the basis of at least one of the associated importance levels and the at least one system status parameter.

Still another embodiment provides a data processing system comprising an event manager residing in memory for initiating a background thread for each instance of an executing application, the background thread being configured to: monitor at least one system status parameter for the data processing system, monitor one or more processes running in the data processing system in order to detect events occurring in the one or more processes, associate an importance level with each occurred event and identify a predetermined action to be taken in the data processing system on the basis of at least one of the associated importance levels and the at least one system status parameter; and a processor for running the one or more processes and the at least one background thread.

### BRIEF DESCRIPTION OF THE DRAWINGS

So that the manner in which the above recited features of the present invention are attained can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with the invention;

FIG. 2 is a relational view of components implementing the invention;

FIG. 3 is a flow chart illustrating an embodiment of event management;

FIG. 4 is a flow chart illustrating selection of a predetermined action to be taken in one embodiment; and

FIG. 5 is a flow chart illustrating an embodiment of logging activity management.

### DETAILED DESCRIPTION OF THE PREFERRED EMBODIMENTS

### Introduction

The present invention is generally directed to a system, method and article of manufacture for event management in data processing systems and more particularly to managing events occurring in data processing systems for providing an effective logging mechanism. Frequently, specific events occurring in data processing systems are precursors of a future application or system failure (in the following referred to as “failure”, for simplicity). In addition, many of the common causes of failures have preceding trends that are recognizable well before the actual failure occurs. In detecting such specific events and recognizing such trends, preventative action can be taken which may be suitable to prevent a failure. If, however, it is not possible to prevent the failure, at least certain actions can be taken to ensure that undesirable effects are minimized. Such actions may include, for example, logging of the proper information related to specific events and trends. Thus, a quick resolution to a problem leading to the failure can be found when the failure occurred. To this end, a reliable determination of the specific events and trends needs to be performed.

Accordingly, in one embodiment an importance level is determined for an event that occurs during execution of a process in a data processing system. The importance level is determined on the basis of trend analysis indicating evolution of the process. The determined importance level is compared with a predetermined threshold value to determine whether the event is a specific event. Only if the determined importance level exceeds the predetermined threshold value, it is assumed that the event is a specific event and a log file entry is created for the occurred event.

Another embodiment employs an analysis of system status parameters indicating system resource usage in order to manage logging activity for a process in the data processing system. Accordingly, at least one system status parameter is monitored for the data processing system. On the basis of the at least one system status parameter the logging activity for the process is managed.

### Preferred Embodiments

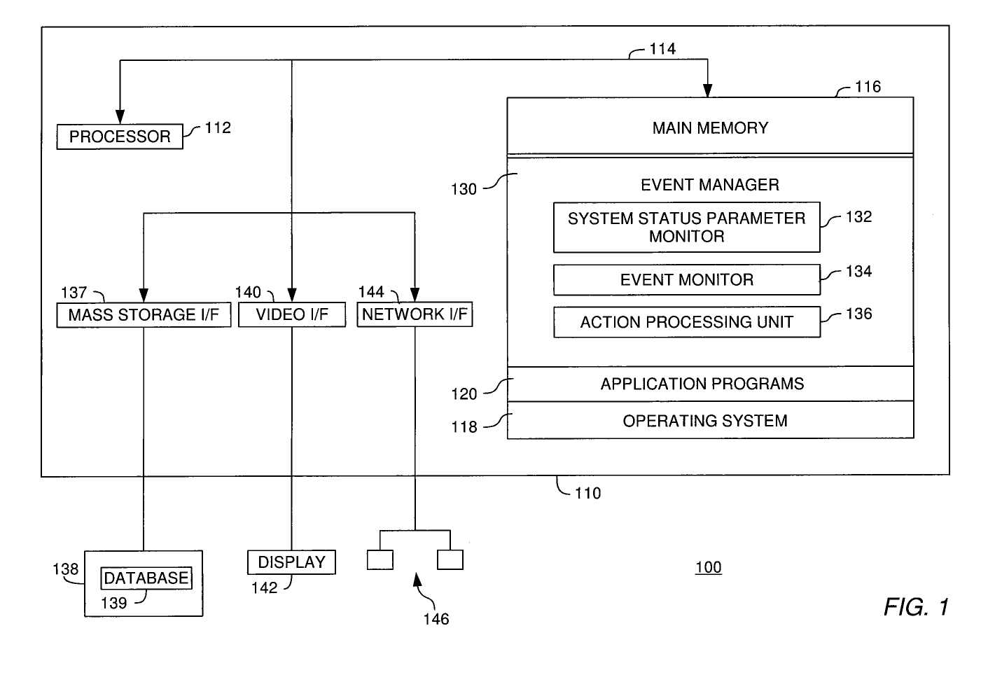

One embodiment of the invention is implemented as a program product for use with a computer system such as, for example, the computer system 110 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

Referring now to FIG. 1, a computing environment 100 is shown. In general, the distributed environment 100 includes a data processing system 110, interchangeably referred to as a computer system 110, and a plurality of networked devices 146. The computer system 110 may represent any type of computer, computer system or other programmable electronic device, including a client computer, a server computer, a portable computer, an embedded controller, a PC-based server, a minicomputer, a midrange computer, a mainframe computer, and other computers adapted to support the methods, apparatus, and article of manufacture of the invention. In one embodiment, the computer system 110 is an eServer iSeries 400 available from International Business Machines of Armonk, N.Y.

Illustratively, the computer system 110 comprises a networked system. However, the computer system 110 may also comprise a standalone device. In any case, it is understood that FIG. 1 is merely one configuration for a computer system. Embodiments of the invention can apply to any comparable configuration, regardless of whether the computer system 110 is a complicated multi-user apparatus, a single-user workstation, or a network appliance that does not have non-volatile storage of its own.

The embodiments of the present invention may also be practiced in distributed computing environments in which tasks are performed by remote processing devices that are linked through a communications network. In a distributed computing environment, program modules may be located in both local and remote memory storage devices. In this regard, the computer system 110 and/or one or more of the networked devices 146 may be thin clients which perform little or no processing.

The computer system 110 could include a number of operators and peripheral systems as shown, for example, by a mass storage interface 137 operably connected to a direct access storage device 138, by a video interface 140 operably connected to a display 142, and by a network interface 144 operably connected to the plurality of networked devices 146. The display 142 may be any video output device for outputting viewable information.

Computer system 110 is shown comprising at least one processor 112, which obtains instructions and data via a bus 114 from a main memory 116. The processor 112 could be any processor adapted to support the methods of the invention.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in the computer system 110 or in the computing environment 100, for example, any storage capacity used as virtual memory or stored on a mass storage device (e.g., direct access storage device 138) or on another computer coupled to the computer system 110 via bus 114.

The memory 116 is shown configured with an operating system 118. The operating system 118 is the software used for managing the operation of the computer system 110. Examples of the operating system 118 include IBM OS/400®, UNIX, Microsoft Windows®, and the like.

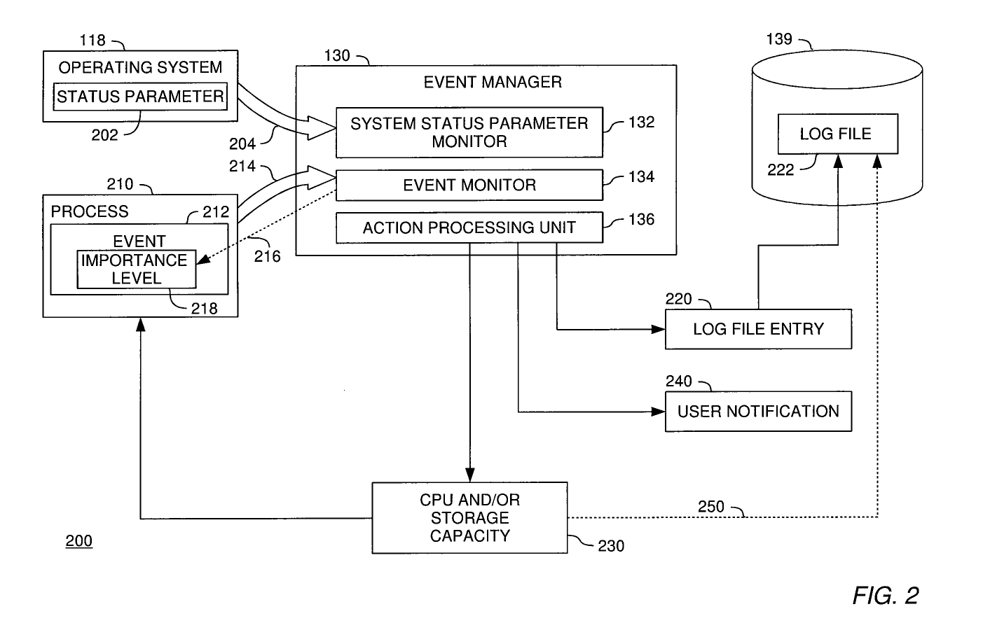

The memory 116 further includes one or more application programs 120 and an event manager 130 having a system status parameter monitor 132, an event monitor 134 and an action processing unit 136. The application programs 120 and the event manager 130 are software products comprising a plurality of instructions that are resident at various times in various memory and storage devices in the computing environment 100. When read and executed by one or more processors 112 in the computer system 110, the application programs 120 and the event manager 130 cause the computer system 110 to perform the steps necessary to execute steps or elements embodying the various aspects of the invention. The application programs 120 may interact with a database 139 (shown in storage 138). The database 139 is representative of any collection of data regardless of the particular physical representation of the data. The event manager 130 is shown having a plurality of constituent elements. However, the event manager 130 may alternatively be implemented without providing separate constituent elements, e.g., as a single software product implemented in a procedural approach. The event manager 130 is further described below with reference to FIG. 2.

FIG. 2 shows an illustrative relational view 200 of the event manager 130 and other components of the invention. The event manager 130 is configured to make a prediction of future failures in the data processing system 110 possible. Further, the event manager 130 provides support for avoiding/resolving problems leading to such failures. In one embodiment the event manager 130 identifies problems by correlating the evolution of one or more processes running on the data processing system 110 with status changes of the data processing system 110. When the correlation results in the identification of a problem which may lead to failure, the event manager identifies a predetermined action to be taken. The predetermined action is either designed to avoid the failure or to identify and collect critical information that permits a quick resolution of the problem. The event manager 130 may identify the critical information by determining events occurring in the one or more processes which are likely to be relevant to the resolution of the identified problem, i.e., for debugging and analysis purposes if the failure occurs.

In one embodiment, the event manager 130 initiates a background thread for each process running on the data processing system 110. A process may be running, for example, for an instance of an executing application. In one embodiment, the background thread is implemented by the constituent functions of the event manager 130, i.e., by the system status parameter monitor 132, the event monitor 134 and the action processing unit 136. These functions and their interaction are now described.

The system status parameter monitor 132 monitors (as indicated by arrow 204) system status parameters 202 for the data processing system 110. The system status parameters 202 may be determined and provided by the operating system 118 using conventional techniques which are well-known in the art. By way of example, system status parameters 202 include used memory, attributed processing capacity, relative storage usage of one or more processes running on the data processing system 110, and the size of one or more log files configured for logging information relating to events occurring during execution of the one or more processes. In one embodiment, the system status parameters 202 may be determined according to a predetermined time schedule. The predetermined time schedule may specify a periodic determination. Or, if a corresponding process is running for an executable instance of an application, the application may indicate time intervals at which time the system status parameters 202 need to be determined.

The event monitor 134 monitors (as indicated by arrow 214) processes 210 running on the data processing system 110 in order to detect events 212 occurring in the processes 210. Furthermore, the event monitor 134 associates an importance level 218 with each occurred event 212 (as indicated by dashed arrow 216). The importance levels for a plurality of possibly occurring events may be application-specific and predefined by an operator. The importance levels may also be autonomously determined by the data processing system 110 on the basis of predefined generic importance patterns. Such generic importance patterns may, for example, indicate that for any application executing in the data processing system 110 events occurring at initialization of the application are more important than events immediately following the initialization. In another embodiment, the importance levels may be autonomously determined by the data processing system 110 on the basis of the system status parameters 202, thereby correlating the occurring events 212 with a current system status. By way of example, any combination of the above-described possibilities is considered. For instance, the importance levels may be autonomously determined by the data processing system 110 on the basis of the system status parameters 202 and additionally be weighted on the basis of the predefined generic importance patterns. Persons skilled in the art will recognize other embodiments for defining or determining the importance levels.

The action processing unit 136 correlates the system status parameters 202 monitored by the system status parameter monitor 132 with the evolution of the processes 210 monitored by the event monitor 134. In addition, the action processing unit 136 analyses the occurred events 212. Thus, the action processing unit 136 determines whether a problem appeared which may be indicative of a possible future failure. If a problem needs to be addressed, the action processing unit 136 identifies a predetermined action to be taken in the data processing system 110. In one embodiment, the predetermined action is identified on the basis of at least one of the associated importance levels 218 and at least one of the system status parameters 202.

The predetermined action to be taken includes managing logging activity of the data processing system 110. If, for instance, the problem is determined on the basis of the system status parameters 202 but cannot be unambiguously attributed to a specific process, the action processing unit 136 may increase logging activity for all processes running on the data processing system 110. If the problem is related to an event in a specific process, a running log process may be initiated to create log file entries 220 for all subsequently occurring events in the specific process. The log file entries 220 are stored in a corresponding log file 222 which is illustratively contained in the database 139. The predetermined action to be taken may further include notification 240 of a user of the occurred event 212 or the appeared problem and acting on allocated processing (CPU) and/or storage capacities 230, e.g., in order to inhibit increased storage and processing capacity usage of the specific process. Acting on allocated CPU and/or storage capacities 230 may additionally include (as indicated by dashed arrow 250) an increase of allocated storage capacity for the log file 222 in the database 139, if logging activity is increased.

It should be noted that the above-described interactions between the constituent functions of the event manager 130 are merely illustrative and not construed for limiting the invention to these described interactions. Those skilled in the art will recognize that only a part of the functions could be used to implement an effective logging activity management mechanism for a process in a data processing system according to the invention. For instance, the system status parameter monitor 132 may monitor at least one system status parameter for the data processing system 110 and the action processing unit 136 may manage the logging activity for the process on the basis of the at least one system status parameter. Thus, implementation of the event monitor 134 may be omitted. Alternatively, the event monitor 134 may detect events occurring during execution of the process and determine an importance level for an occurred event on the basis of trend analysis indicating evolution of the process. The trend analysis illustratively consists of a determination of at least one process performance parameter such as used memory, allocated processing capacity or duration between a process request and result delivery. The action processing unit 136 may then compare the determined importance level with a predetermined threshold value and create a log file entry for the occurred event only if the determined importance level exceeds the predetermined threshold value. Thus, implementation of the system status parameter monitor 132 may be omitted. However, it will be recognized by the skilled person that in both cases the logging activity is managed either on the basis of an absolute or on the basis of a relative importance of corresponding process events or activities. Thus, in both cases an improved and effective logging activity management mechanism is provided.

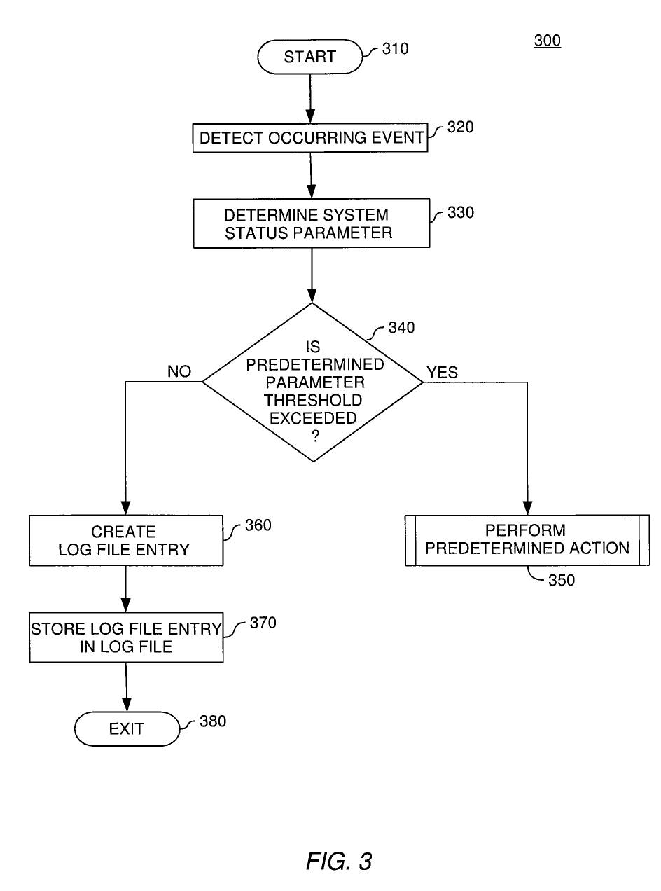

An embodiment of the operation of an event manager (e.g., event manager 130 of FIGS. 1 and 2) is described below with reference to FIGS. 3-5. For simplicity, in the following explanations reference is only made to the event manager as such without explicitly referring to individual constituent functions thereof. Moreover, by referring only to the event manager as such, an implementation thereof wherein separate constituent functions cannot unambiguously be distinguished is contemplated.

Referring now to FIG. 3, an illustrative method 300 is shown that represents a sequence of operations as performed by the event manager in a data processing system (e.g., data processing system 110 of FIG. 1). Method 300 is entered at step 310. At step 320, the event manager detects an occurring event (e.g., event 212 of FIG. 2). At step 330, the event manager determines one or more system status parameters (e.g., system status parameters 202 of FIG. 2).

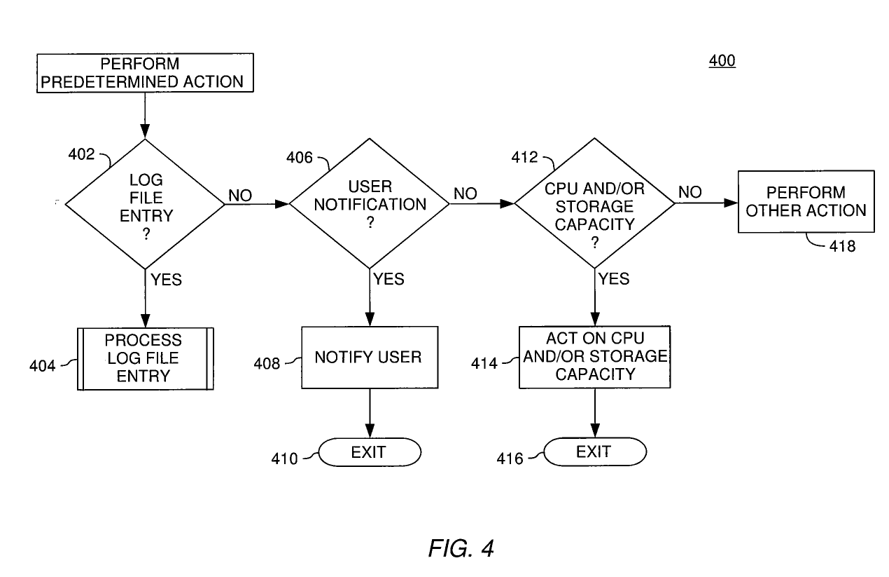

The event manager then establishes a relation between the occurred event and the one or more system status parameters. To this end, the event manager determines at step 340 whether the one or more system status parameters exceed associated predetermined parameter thresholds. Specifically, if one of the one or more system status parameters exceeds its associated predetermined parameter threshold, it is assumed that the occurred event influenced the overall performance of the data processing system and caused a system status change. In this case, at step 350, the event manager performs a predetermined action as described above. Selection of the predetermined action to be taken is described below with reference to FIG. 4.

If, to the contrary, none of the system status parameters exceed their associated predetermined parameter threshold, it may be assumed that the data processing system is correctly performing and that the system status did not change. In this case the event manager may create a log file entry (e.g., log file entry 220 of FIG. 2) at step 360 for the occurred event for tracking or reporting purposes. At step 370, the event manager stores the log file entry in a corresponding log file (e.g., log file 222 of FIG. 2). Method 300 then exits at step 380. Alternatively, the event manager may renounce to performance of steps 360 and 370 as it is assumed that the data processing system is correctly performing. Thus, it may be assumed that no log file entry needs to be created so that method 300 may exit at step 380.

Referring now to FIG. 4, an illustrative method 400 for selecting a predetermined action to be taken according to step 350 of FIG. 3 is described. In one embodiment, the selection is performed on the basis of user-specified selection criteria. User-specified criteria refer to settings that are predefined by a user. For instance, a user may define that certain events require a user notification while other events require only an increase of logging activity. Specifically, if correct performance of an application is critical to the business of a user, the user may wish to be notified whenever a problem occurs in order to take desired preventative actions as soon as possible in order to prevent failure. If performance of the application is not particularly important, failure may not be critical for the business of the user so that an increase of logging activity would be sufficient for resolving the problem once failure occurs.

Selection of a predetermined action may also be performed on the basis of application-specific criteria or system-determined criteria. Application-specific criteria refer to criteria which are hard-coded in an application and, thus, predefined by the programmer. System-determined criteria refer to criteria which are hard-coded in the data processing system, e.g., in the operating system 118 of FIG. 1, and thus independent on the user or application.

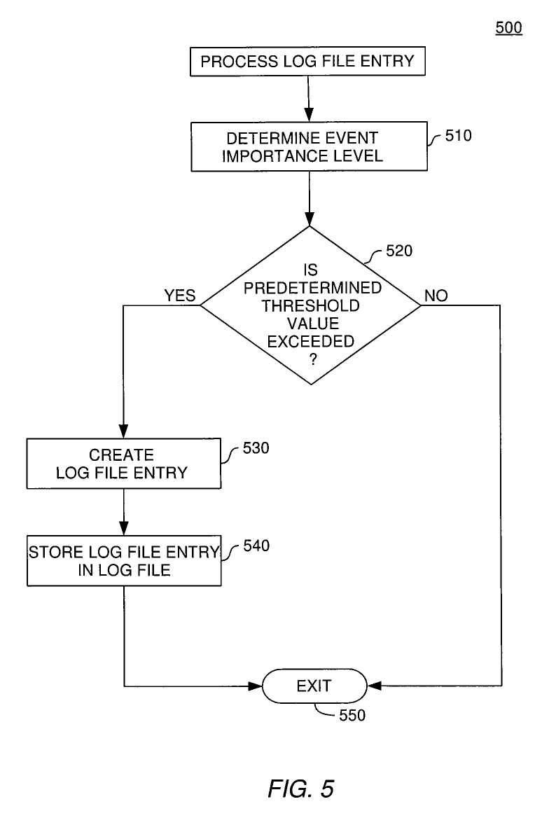

In any case, the selection of the predetermined action to be taken starts at step 402. At step 402, the event manager determines whether logging activity should be increased. Illustratively, the event manager determines whether a log file entry (e.g., log file entry 220 of FIG. 2) should be created for the occurred event, thereby increasing the logging activity. If it is determined that logging activity should be increased, processing continues at step 404, where the log file entry for the occurred event is processed. Processing of the log file entry is described below with reference to FIG. 5.

If it is determined that logging activity should not to be increased, the selection continues at step 406. At step 406, the event manager determines whether a user notification is required. If it is determined that user notification (e.g., user notification 240 of FIG. 2) is required, the event manager notifies the user at step 408. Notification may be performed by conventional techniques such as displaying a visual indication on a display device (e.g., display 142 of FIG. 1). Processing then exits at step 410.

If it is determined that the user should not be notified, the selection continues at step 412. At step 412, the event manager determines whether action on processing and/or storage capacities (e.g., CPU and/or storage capacities 230 of FIG. 2) is required. If it is determined that such action is required, the event manager identifies a specific action to be performed, e.g., limiting the available storage for a process, and performs the action at step 414. Action on processing and/or storage capacities may also be performed by conventional techniques. Processing then exits at step 416.

If it is determined that such action is not required, processing proceeds from step 412 to step 418. Step 418 is representative of any other type of predetermined action to be taken by the event manager contemplated as embodiments of the present invention. However, it should be understood that embodiments are contemplated in which less then all the available predetermined actions to be taken are implemented. For example, in a particular embodiment only logging activity management is used. In another embodiment, only user notification and action on processing and/or storage capacities are used. Furthermore, more than one predetermined action can be performed. For instance, logging activity may be increased and, additionally, the user may be notified. In this case, instead of exiting method 400 after performance of a predetermined action according to one of steps 404, 408, 414, the method 400 continues subsequently with one of steps 406, 412 and 418, respectively. Such a continuation may be made independent on the respective determinations made in one of steps 402, 406 or 412.

Referring now to FIG. 5, an illustrative method 500 for processing a log file entry (e.g., log file entry 220 of FIG. 2) according to step 404 of FIG. 4 is described. At step 510, the event manager determines and associates an importance level with the occurred event. At step 520, the event manager determines whether the importance level exceeds a predetermined threshold value. The predetermined threshold value may, for instance, be defined on the basis of user input or on the basis of predefined process parameters. Accordingly, a user may provide a plurality of predetermined threshold values for possibly occurring events, which may be based on the user's experience or an analysis of respective training data indicating an absolute or relative importance of occurring events. The predefined process parameters refer, for example, to common performance parameters of the process which may be determined by previous execution(s) of a corresponding process. Accordingly, the predefined process parameters include parameters such as memory used by the process and processing capacity allocated to the process.

Specifically, step 520 represents a determination by the event manager as to whether the occurred event is actually related to a problem which may cause a failure in the future or not. More specifically, according to the determination made at step 340 in FIG. 3 it is assumed at step 520 that the occurred event potentially represents a problem that may lead to failure. However, it is possible that the system status parameters exceed their associated predetermined parameter thresholds only because of a general load peak occurring in the data processing system that usually ceases without resulting in a failure. Thus, in order to ensure that the occurred event actually relates to a problem and that a log file entry needs to be created for the occurred event, an additional verification may be made at step 520. Accordingly, if the importance level exceeds the predetermined threshold value, it is assumed that the occurred event is actually related to a problem which may cause failure of the data processing system in the future. Therefore, the event manager creates a log file entry (e.g., log file entry 220 of FIG. 2) at step 530 for the occurred event for debugging/analysis purposes in order to allow for a quick resolution of the problem if failure occurs. At step 540, the event manager stores the log file entry in a corresponding log file (e.g., log file 222 of FIG. 2). Method 500 then exits at step 550. If, however, the importance level does not exceed the predetermined threshold value, it is assumed that the occurred event is not related to a problem which may cause failure of the data processing system in the future. Accordingly, method 500 exits at step 550.

It should be understood that the foregoing are merely representative embodiments, and that the invention admits of many other embodiments. For example, it is also contemplated that a background thread implementing an event manager can be started when an application comes up as part of a logging component's initialization. The logging component reads a configuration file, collects user customized information on what types of events the logging component should be looking for and what actions the logging component should take if such events occur. There can be multiple specialized background threads created to handle different events for scalability. The logging component can be implemented such that changes can be made to it dynamically. For instance, if the logging component receives a request to log a debug message but a logging level for logging exclusively error messages is set, the debug message is not logged. In this case, the logging component can receive an update command from the background thread requesting the logging component to update itself in order to increase logging activity for logging also debug messages. Accordingly, after the update the logging component will also log debug messages.

In various embodiments, the invention provides numerous advantages over the prior art. For instance, memory leaks representing commonly occurring problems in data processing systems may easily be recognized and prevented according to the invention. Memory leaks refer to unused memory which is allocated to a process or application such that at least one active user reference to this memory continuously exists. The at least one active user reference prevents returning this memory for reuse by another application or process. Accordingly, by increasing the number of memory leaks in a data processing system, the unused memory is increased and, consequently, the available memory shrinks.

Such memory leaks are notoriously hard to find and typically recreate only over very long periods of time, as memory generally leaks slowly until all available memory resources are gone. In the present context “recreate” means “to occur again”. In other words, memory leaks are problems that are generally only recognized after long periods of running because of an occurring failure, e.g., the system crashes. But the memory leak problem typically exists all along running. It just does not cause any obvious outward signs of failure. Even in languages such as Java which has garbage collection support, memory leaks are a problem. A Java Virtual Machine can only cleanup memory if there are no user references to it anymore. If however, for example, a globally scoped hash table is created and new objects are continuously stacked into it, none of them ever becomes unreachable if the reference to the hash table itself is not lost. Eventually, the hash table will even grow to consume the systems resources entirely. In this case simply logging occurring events in the data processing system according to conventional techniques would be very unsatisfactory. In fact, as the memory leaks over a long period of time a corresponding conventional log file can be very voluminous. Thus, analyzing the corresponding log file would be very time-consuming and difficult as it would be hard for an operator to identify the relevant information. According to the invention, the potential for memory leaks and a related subsequent failure may be determined in advance. Thus, an appropriate preventative action may be taken in advance to the failure. In one aspect of the invention such action may, for instance, be taken against a logging component by increasing its activity.

According to another aspect, a process trend analysis is performed by monitoring one or more system status parameters. For example, most applications or processes normally reach a so-called “steady-state” by which they are basically using new memory at the same rate at which they are returning old memory. If an application never reaches the steady-state, it will eventually crash and cause failure because of memory leaks. In other words, if an application that has been running at a given level for a longer period of time begins to consume more and more resources, this indicates that something has changed that could potentially be significant. Accordingly, this determination may prompt logging at an increased level as things could be moving towards failure. Thus, by performing the trend analysis, occurring events are detected and all events which require an increased attention are identified. This identification may be performed by associating an importance level with each occurred event as described above.

In addition to memory leaks, many other types of situations can warrant execution of preventative actions. Such situations include, for instance, threads that have a stack that is not changing (looping) or increasing numbers of blocked threads (deadlocks) in a data processing system. In these cases, the system could be configured so that areas experiencing trouble would be the only areas in which the background thread increases logging information. Furthermore, applications in which response time is a critical feature can warrant execution of preventative actions. In such applications the system could be configured such that the background thread increases logging information immediately once the required response times are not being met consistently to provide immediately relevant debugging information to an operator. Once the required response times are met consistently again, the background thread may decrease the logging information to the previous level.

Another illustrative application of the present invention is with respect to application programming interfaces such as Java Database Connectivity. Java Database Connectivity (JDBC) is an application program interface (API) specification for connecting programs written in Java to the data in popular databases. The application program interface allows users to encode access request statements in Structured Query Language (SQL) that are then passed to the program that manages the database. The database manager returns the results through a similar interface. One commercially available JDBC driver has a statement handle array where it stores all database resources that are in use. If all database handles are in use, the system is considered to be “out of resources” despite the availability of sufficient memory. Therefore, the burden is on users to ensure that any JDBC connections previously opened are eventually closed. Inevitably, however, users fail to properly manage these resources eventually leading to an unacceptably high unreachable number of resources. In one embodiment of the invention, a logging plug-in is built specifically to watch the statement handle structure. During what appears as normal operation, the logging level is low. Upon detecting a threshold condition indicating a resource problem, logging activity is increased. The threshold condition may be, for example, a predetermined number of handles in handle structure, a certain percentage/number of handles that has not been used in a certain amount of time, etc.

In another embodiment, the logging plug-in described above may perform preventative actions in addition to logging. For example, in the case of the growing number of statement handles, there may be a last accessed flag for each statement in the statement handle array. The plug-in may be configured to increase logging, close the connection explicitly and close database resources explicitly. This could result in operations failing, but preserves the overall system and application from failure.

While the foregoing is directed to embodiments of the present invention, other and further embodiments of the invention may be devised without departing from the basic scope thereof, and the scope thereof is determined by the claims that follow.

What is claimed is:

1. A method of managing a logging activity for a process in a data processing system, comprising:
monitoring at least one system status parameter for the data processing system; and
managing the logging activity for the process on the basis of the monitored at least one system status parameter, wherein managing the logging activity comprises selectively generating log file entries in a computer readable storage medium on the basis of the monitored at least one system status parameter.

2. The method of claim 1, wherein the process is an executable instance of an application.

3. The method of claim 1, wherein managing the logging activity comprises increasing the logging activity.

4. The method of claim 1, further comprising:
monitoring one or more processes running in the data processing system in order to detect events occurring in the one or more processes; and
associating an importance level with each occurred event; and
wherein managing the logging activity comprises managing the logging activity on the basis of the at least one system status parameter and at least one of the associated importance levels.

5. The method of claim 1, wherein the at least one system status parameter comprises at least one of used memory, attributed processing capacity, relative storage usage of a process and a size of a log file configured for logging information relating to events occurring during execution of the process.

6. A computer readable storage medium comprising:
an event manager program for initiating a background thread for each instance of an executing application in a data processing system, the background thread being configured to:
monitor at least one system status parameter for the data processing system;
monitor one or more processes running in the data processing system in order to detect events occurring in the one or more processes;
associate an importance level with each occurred event on the basis of trend analysis indicating evolution of the process;
identify a predetermined action to be taken in the data processing system on the basis of at least one of the associated importance levels and the at least one system status parameter; and
perform the predetermined action in the data processing system.

7. The computer readable storage medium of claim 6, wherein at least one of the one or more processes is an executable instance of an application.

8. The computer readable storage medium of claim 7, wherein the at least one system status parameter comprises at least one of used memory, attributed processing capacity, relative storage usage of the one or more processes and a size of one or more log files configured for logging information relating to events occurring during execution of the one or more processes.

9. The computer readable storage medium of claim 7, wherein the predetermined action to be taken comprises at least one of generating a log file entry for a corresponding occurred event, notifying a user of the corresponding occurred event, initiating a running log process to create log file entries for all subsequently occurring events and inhibiting increased storage and processing capacity usage of a corresponding process.

10. A data processing system, comprising:
an event manager residing in memory for initiating a background thread for each instance of an executing application, the background thread being configured to monitor at least one system status parameter for the data processing system;
monitor one or more processes running in the data processing system in order to detect events occurring in the one or more processes;
associate an importance level with each occurred event on the basis of trend analysis indicating evolution of the process;
identify a predetermined action to be taken in the data processing system on the basis of at least one of the associated importance levels and the at least one system status parameter; and
perform a predetermined action in the data processing system; and
a processor for running the one or more processes and the at least one background thread.
